(19) United States
(12) Patent Application Publication
(10) Pub. No.: US 2021/0063614 A1
(43) Pub. Date: Mar. 4, 2021

(54) LENS MODULE

(71) Applicant: AAC Optics Solutions Pte. Ltd., Singapore City (SG)

(72) Inventor: Yuchan Gao, Shenzhen (CN)

(21) Appl. No.: 16/992,101

(22) Filed: Aug. 13, 2020

(30) Foreign Application Priority Data
Aug. 26, 2019 (CN) 201921395506.1

(51) Int. Cl. G02B 5/00; G02B 7/02

(52) U.S. Cl. CPC G02B 5/003; G02B 7/021

(57) ABSTRACT

The present disclosure provides a lens module. The lens module includes a lens barrel defining an accommodating space, a lens group and a spacer ring accommodated in the accommodating space. The lens group at least includes a first lens and a second lens arranged on an image side of the first lens. The spacer ring is sandwiched between the first lens and the second lens. The spacer ring includes a spacer ring body and a light-shielding sheet embedded in the spacer ring body. Compared with the related technology, the lens module provided in the present disclosure has a better imaging quality.

### TECHNICAL FIELD

The present disclosure relates to the field of optical imaging technology, in particular to a lens module.

### BACKGROUND

With the continuous development of science and technology, electronic devices are continuously developing towards intelligence. In addition to digital cameras, portable electronic devices such as tablet computers and mobile phones are also equipped with lens modules having photo shooting and video shooting functions, so as to meet the needs of users to take photos at any time.

The lens module in the related technology includes a lens barrel, a lens group and a spacer ring accommodated in the lens barrel, and the spacer ring is sandwiched between two adjacent lenses of the lens group.

However, the spacer ring of the lens module in the related technology is usually plastic injection molded, and the reflectivity of the plastic surface is high, which causes the stray light to be easily generated during the use of the lens module, and thus affects the imaging quality.

Therefore, it is necessary to provide a new lens module to solve the above problems.

### SUMMARY

With respect to the technical problems that the lens module in related technology is easy to generate a stray light due to the high reflectivity of a surface of a spacer ring, which affects the imaging quality, the present disclosure provides a lens module with better imaging quality.

A lens module includes a lens barrel defining an accommodating space, a lens group and a spacer ring accommodated in the accommodating space. The lens group at least includes a first lens and a second lens arranged on an image side of the first lens. The spacer ring is sandwiched between the first lens and the second lens. The spacer ring includes a spacer ring body and a light-shielding sheet embedded in the spacer ring body.

As an improvement, the spacer ring is annular. The spacer ring body includes an image-side surface adjacent to an image side of the lens module, an object-side surface adjacent to an object side of the lens module, and an inner side surface and an outer side surface connecting the image side and the object side. The inner side surface is located on a side adjacent to an optical axis of the lens module, the light-shielding sheet is located on a side adjacent to the inner side surface, and the outer side surface abuts against the lens barrel.

As an improvement, the light-shielding sheet includes a fixing portion embedded in the spacer ring body and a light-shielding portion bending from one end of the fixing portion adjacent to the optical axis and extending along an extending direction of the inner side surface.

As an improvement, the inner side surface is arranged to inclinedly extend from the image-side surface to the object-side surface towards the optical axis. The light-shielding portion has a part embedded in the spacer ring body and the other part exposed to the accommodating space from the inner side surface.

As an improvement, the light-shielding portion is located in a middle of the inner side surface.

As an improvement, the fixing portion is arranged in parallel with the image-side surface.

As an improvement, the first lens includes a first optical portion for imaging and a first peripheral portion arranged around the first optical portion, and the second lens includes a second optical portion for imaging and a second peripheral portion arranged around the second optical portion. The object-side surface correspondingly abuts against the first peripheral portion, and the image-side surface correspondingly abuts against the second peripheral portion.

As an improvement, the spacer ring body is made of plastic.

As an improvement, the light-shielding sheet and the spacer ring body are integrally injection-molded.

As an improvement, a surface of the light-shielding sheet is covered with a carbon layer.

Compared with the related technology, the lens module provided in the present disclosure has an improved imaging quality by being provided with the light-shielding sheet embedded in the spacer ring body which has a lower reflectivity and thus effectively reduce a light reflection and avoid generating stray light.

### BRIEF DESCRIPTION OF THE DRAWINGS

In order to illustrate the technical solution in the embodiments of the present disclosure more clearly, the accompanying drawings used in the description of the embodiments are briefly introduced below. It is apparent that the drawings descripted below are only some embodiments of the present disclosure. For those skilled in the art, other drawings may be obtained in accordance with these drawings without any creative work, where:

FIG. 1 is a schematic structural diagram of a lens module provided by the present disclosure;

FIG. 2 is a partially enlarged diagram of the area II shown in FIG. 1.

### DETAILED DESCRIPTION

The technical solutions in the embodiments of the present disclosure will be clearly described in details with reference to the accompanying drawings in the present disclosure. It is evident that the embodiments described are only some rather than all embodiments in the present disclosure. Based on the embodiments of the present disclosure, all other embodiments obtained by those of ordinary skills in the art without any creative work shall fall within the protection scope of the present disclosure.

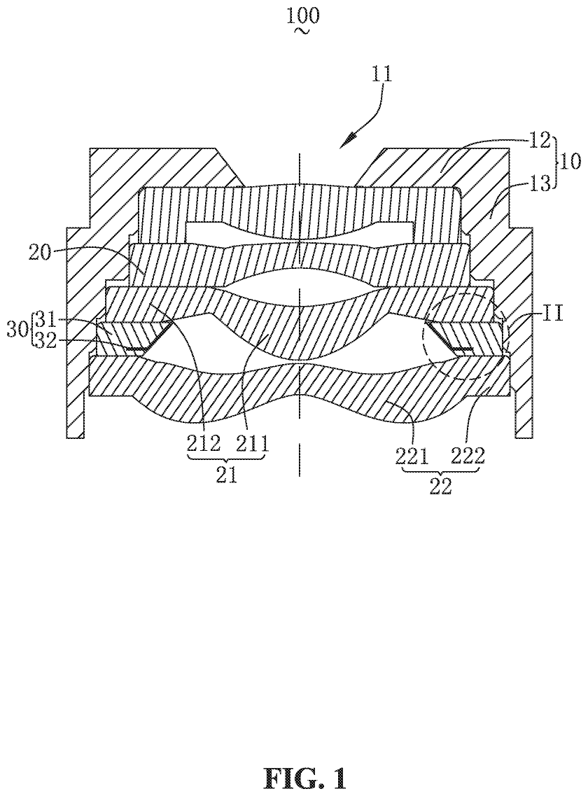

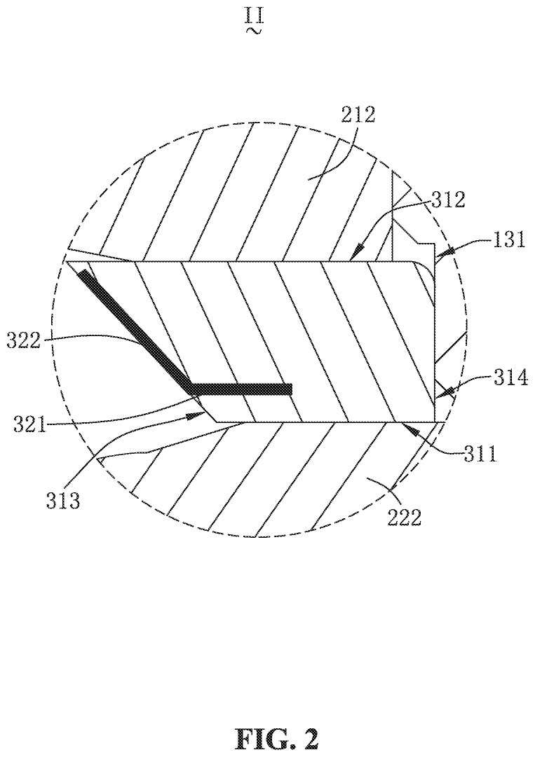

Referring to FIG. 1 and FIG. 2, the present disclosure provides a lens module 100. The lens module 100 may be applied to portable devices, such as a video camera, a camera, a mobile phone and other devices. The lens module 100 includes a lens barrel 10 defining an accommodating space, a lens group 20 and a spacer ring 30 that are accommodated in the accommodating space.

The lens barrel 10 includes a first barrel wall 12 defining a light through hole 11 and a second barrel wall 13 bending and extending from the first barrel wall 12 toward an image side, and the light through hole 11 communicates with the accommodating space. The second barrel wall 13 includes an inner surface 131 that encloses the accommodating space together with the first barrel wall 12.

The lens group 20 at least includes a first lens 21 and a second lens 22 arranged on an image side of the first lens 21.

It should be noted that in this embodiment, the lens group 20 has a four-lens structure, where the third lens in a direction from an object side to the image side is the first lens 21, and the fourth lens in the direction from the object side to the image side is the second lens 22. Alternatively, in other embodiments, the number of the lenses in the lens group 20 may further be any other number. In this embodiment, four lenses are merely taken as an example for illustration. Meanwhile, in other embodiments, the first lens 21 and the second lens 22 may also be located at any position according to actual needs.

The first lens 21 includes a first optical portion 211 for imaging and a first peripheral portion 212 arranged around the first optical portion 211. The second lens 22 includes a second optical portion 221 for imaging and a second peripheral portion 222 arranged around the second optical portion 221.

The spacer ring 30 is sandwiched between the first lens 21 and the second lens 22. Specifically, the spacer ring 30 includes a spacer ring body 31 and a light-shielding sheet 32 embedded in the spacer ring body 31. The spacer ring body 31 is made of plastic. Preferably, the light-shielding sheet 32 and the spacer ring body 31 are integrally injection-molded, which may effectively improve a connection stability between the light-shielding sheet 32 and the spacer ring body 31, so that the light-shielding sheet 32 is not vulnerable to falling off from the spacer ring body 31.

The spacer ring 30 is annular. The spacer ring body 31 includes an image-side surface 311 adjacent to the image side of the lens module 100, an object-side surface 312 adjacent to the object side of the lens module 100, and an inner side surface 313 and an outer side surface 314 connecting the image-side surface 311 and the object-side surface 312. The inner side surface 313 is located on a side adjacent to an optical axis of the lens module 100 and is arranged to inclinedly extend from the image-side surface 311 to the object-side surface 312 towards the optical axis. The light-shielding sheet 32 is located on a side adjacent to the inner side surface 313. The image-side surface 311 correspondingly abuts against the second peripheral portion 222, the object-side surface 312 correspondingly abuts against the first peripheral portion 212, and the outer side surface 314 correspondingly abuts against the inner surface 131, so that the spacer ring 30 is tightly connected with the lens barrel 10, the first lens 21 and the second lens 22.

The light-shielding sheet 32 includes a fixing portion 321 embedded in the spacer ring body 31 and a light-shielding portion 322 bending from one end of the fixing portion 321 adjacent to the optical axis and extending along an extending direction of the inner side surface 313. The light-shielding portion 322 has a part embedded in the spacer ring body 31 and the other part exposed to the accommodating space from the inner side surface 313. The light-shielding portion 322 has a low reflectivity, which may effectively reduce a light reflection and improve an imaging quality. Specifically, the light-shielding portion 322 is located in a middle of the inner side surface 313, so that the light reflection may be well reduced.

The fixing portion 321 is arranged in parallel with the image side surface 311, which results in easy processing of the light-shielding sheet 32, convenient and accurate positioning of the parts during production, and improved yield.

Preferably, a surface of the light-shielding sheet 32 is covered with a carbon layer. The carbon layer characterized with a low reflectivity may effectively reduce the light reflection.

It can be understood that in this embodiment, the light-shielding portion 322 is located in the middle of the inner side surface 313, and the light-shielding portion 322 partly protrudes from the inner side surface 313, so that the light reflection is reduced through the light-shielding portion 322. Alternatively, in other embodiments, the surface of the light-shielding portion 322 adjacent to the optical axis may be flush with the inner side surface 313, that is, the light-shielding portion 322 may not protrude from the inner side surface 313, as long as the light-shielding portion 322 is exposed to the accommodating space from the inner side surface 313. Furthermore, the light-shielding portion 322 may completely cover the inner side surface 313, that is, the surface of the spacer ring body 31 adjacent to the optical axis is formed by the light-shielding portion 322, so as to better reduce the light reflection. In other words, the present disclosure does not impose any restrictions on a connecting configuration between the light-shielding sheet 32 and the spacer ring body 31, as long as the light-shielding sheet 32 is embedded in the spacer ring body 31 to reduce the light reflection and improve the imaging effect.

Compared with the related technology, the lens module provided in the present disclosure has an improved imaging quality by being provided with the light-shielding sheet embedded in the spacer ring body which has a lower reflectivity and thus effectively reduce a light reflection and avoid generating stray light.

The description above is merely embodiments of the present disclosure. It should be appreciated that those of ordinary skills in the art may make improvements without departing from the inventive concept of the present disclosure, such improvements, however, fall within the protection scope of the present disclosure.

What is claimed is:

1. A lens module, comprising a lens barrel defining an accommodating space, a lens group and a spacer ring accommodated in the accommodating space, the lens group at least comprising a first lens and a second lens arranged on an image side of the first lens, the spacer ring being sandwiched between the first lens and the second lens, the spacer ring comprising a spacer ring body and a light-shielding sheet embedded in the spacer ring body.

2. The lens module according to claim 1, wherein the spacer ring is annular, the spacer ring body comprises an image-side surface adjacent to an image side of the lens module, an object-side surface adjacent to an object side of the lens module, and an inner side surface and an outer side surface connecting the image-side surface and the object-side surface, the inner side surface is located on a side adjacent to an optical axis of the lens module, the light-shielding sheet is located on a side adjacent to the inner side surface, and the outer side surface abuts against the lens barrel.

3. The lens module according to claim 2, wherein the light-shielding sheet comprises a fixing portion embedded in the spacer ring body and a light-shielding portion bending from one end of the fixing portion adjacent to the optical axis and extending along an extending direction of the inner side surface.

4. The lens module according to claim 3, wherein the inner side surface is arranged to inclinedly extend from the image-side surface to the object-side surface towards the optical axis, and the light-shielding portion has a part embedded in the spacer ring body and the other part exposed to the accommodating space from the inner side surface.

5. The lens module according to claim 4, wherein the light-shielding portion is located in a middle of the inner side surface.

6. The lens module according to claim 3, wherein the fixing portion is arranged in parallel with the image-side surface.

7. The lens module according to claim 2, wherein the first lens comprises a first optical portion for imaging and a first peripheral portion arranged around the first optical portion, and the second lens comprises a second optical portion for imaging and a second peripheral portion arranged around the second optical portion, the object-side surface correspondingly abuts against the first peripheral portion, and the image-side surface correspondingly abuts against the second peripheral portion.

8. The lens module according to claim 1, wherein the spacer ring body is made of plastic.

9. The lens module according to claim 8, wherein the light-shielding sheet and the spacer ring body are integrally injection-molded.

10. The lens module according to claim 1, wherein a surface of the light-shielding sheet is covered with a carbon layer.
